(19) United States
(12) Patent Application Publication
(10) Pub. No.: US 2026/0211122 A1
(43) Pub. Date: Jul. 23, 2026

(54) DRONE CONTROL DEVICE AND DRONE CONTROL METHOD

(71) Applicant: Qisda Corporation, Taoyuan City (TW)

(72) Inventors: Hsiang-Jui LIAO, Taoyuan City (TW); Ming-Sheng YANG, Taoyuan City (TW); Kuo-Zhi FANG, Taoyuan City (TW)

(73) Assignee: Qisda Corporation, Taoyuan City (TW)

(21) Appl. No.: 19/440,777

(22) Filed: Jan. 6, 2026

(30) Foreign Application Priority Data
Jan. 14, 2025 (TW) 114101462

(51) Int. Cl. G01S 19/21; G05D 1/248; G05D 1/69; G05D 1/85; G05D 109/20

(52) U.S. Cl. CPC G01S 19/21; G05D 1/248; G05D 1/69; G05D 1/857; G05D 2109/20

(57) ABSTRACT

A drone control method includes the following steps. A drone is configured to perform a mission to obtain sensitive data. When the satellite navigation system of the drone is attacked, the drone enters an emergency mode and sends a signal to other drones performing the mission.

This application claims the benefit of Taiwan application Serial No. 114101462, filed Jan. 14, 2025, the subject matter of which is incorporated herein by reference.

### BACKGROUND OF THE INVENTION

### Field of the Invention

The invention relates in general to a drone, and more particularly to a drone control device and a drone control method.

### Description of the Related Art

In order to realize autonomous flight and perform specific tasks of drones, the global navigation satellite system (GNSS) signals are usually used to provide drones with accurate positioning information and navigation capabilities. However, during the signal transmission process, GNSS signals are susceptible to various interferences and attacks, which may come from natural environmental influences (such as electromagnetic interference) or malicious attacks (such as signal deception, electronic warfare interference, etc.).

In addition, the solutions provided by related technologies are also difficult to quickly identify and distinguish the types of interference to GNSS signals (for example, signal masking, signal deception, etc.). This will result in the drone being unable to quickly take effective anti-interference measures when encountering GNSS signal interference, and therefore the risk of flight mission failure or flight accidents is higher.

### SUMMARY OF THE INVENTION

The present invention relates to a drone control device and a drone control method, which are used to solve the problems of drone flight safety and data confidentiality.

According to one aspect of the present invention, a drone control method is provided, including the following steps. A drone is used to perform a mission to obtain sensitive data. When the satellite navigation system of the drone is attacked, the drone enters an emergency mode and sends a signal to other drones performing the mission.

According to one aspect of the present invention, a drone control method is provided, including the following steps. Confirm that the cover of the drone has been opened. Confirm whether the drone is in a normal startup state. When the drone is normally powered on, the satellite navigation system of the drone is activated to confirm whether the drone enters a designated area. When the drone enters the designated area, the drone enters a disassembly mode to obtain sensitive data stored in the drone.

According to one aspect of the present invention, a drone control device is provided, including a control unit and a storage unit. The control unit is configured to perform a mission. The storage unit is configured to store sensitive data. When the satellite navigation system of the drone is attacked, the drone enters an emergency mode and sends a signal to other drones performing the mission.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flow chart of a drone control method according to an embodiment of the present invention.

FIG. 2 is a flow chart of a drone control method according to another embodiment of the present invention.

FIG. 3 is a schematic diagram of a drone control device according to an embodiment of the present invention.

### DETAILED DESCRIPTION OF THE INVENTION

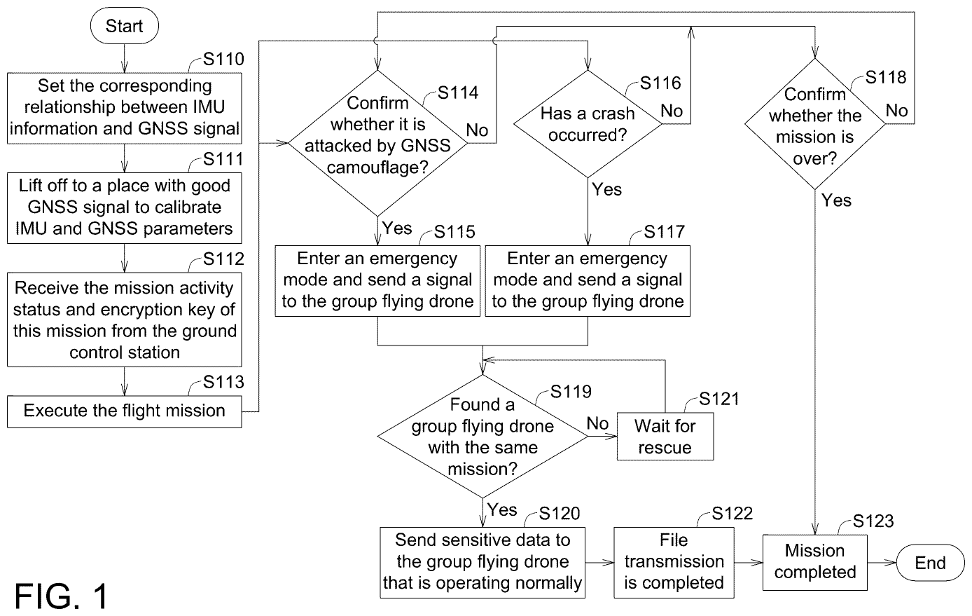

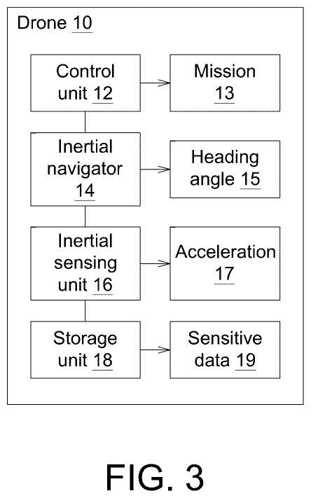

Referring to FIGS. 1 and 3, FIG. 1 is a flow chart of a method for controlling a drone 10 according to an embodiment of the present invention, and FIG. 3 is a schematic diagram of a control device for a drone 10 according to an embodiment of the present invention. In one embodiment, the control device for the drone 10 of FIG. 3 is configured to execute each step of the method for controlling the drone 10 described in FIG. 1.

In one embodiment, the drone control device includes a control unit 12, an inertial navigator 14, an inertial sensing unit 16, and a storage unit 18. The control unit 12 is configured to execute a mission 13, such as a flight mission. The inertial navigator 14 is configured to calculate the heading angle 15 of the drone 10. The inertial sensing unit 16 is configured to determine the acceleration 17, angular velocity and/or geomagnetic field information of the drone 10. The storage unit 18 is configured to store sensitive data 19.

The control unit 12 includes, for example, a flight analyzer and a flight controller. The flight analyzer is configured to calculate the target flight speed and target flight altitude of the drone 10 using GNSS signals, and the flight controller is configured to control the flight of the drone 10 according to the target flight speed and target flight altitude. Therefore, the drone 10 can plan a predetermined flight path through the GNSS signals received by the control unit 12 to perform a mission 13. The drone 10 itself can be equipped with a basic GNSS chip for positioning without the need for additional transmission technology, and the flight controller can enable the drone 10 to automatically perform a pre-scheduled mission based on the latitude and longitude of the destination.

In one embodiment, the mission 13 is, for example, to perform a terrain survey mission or an intelligence search mission. For example, the drone 10 is configured to take pictures of the terrain data of the destination, enemy camp data, aircraft parking points or aircraft equipment, warehouse aerial photos, etc. These pictures can be stored in the storage unit 18 of the drone 10 as sensitive data 19, and then the drone 10 flies back to its own camp to archive or decode these pictures for our analysis, such as enemy situation analysis.

The inertial sensing unit 16 includes an accelerometer, a gyroscope and a magnetometer. The accelerometer is configured to measure the acceleration information of the drone 10 in multiple spatial directions, the gyroscope is configured to measure the rotational angular velocity of the drone 10 during flight, and the magnetometer is configured to measure the geomagnetic field information of the drone 10 in real time. The geomagnetic field information is configured to determine the current direction of the drone 10 in the GNSS signals. The typical configuration is to use an accelerometer, a gyroscope and a magnetometer on each directional axis to measure the attitude on the three directional axes, namely the yaw angle, pitch angle and roll angle.

The inertial navigator 14 can receive the initial position and speed provided by the global satellite system. After that, the inertial navigator 14 continuously updates the current position and speed by integrating and calculating the information measured by the inertial sensing unit 16 such as the accelerometer, gyroscope and magnetometer. Therefore, after the initial conditions are given, the inertial navigator 14 can determine the current position, direction and speed of the drone 10 without the need for external GNSS signals. However, small errors of the inertial sensing unit 16 will accumulate into large errors over time, and the errors are generally proportional to time. Therefore, the inertial navigator 14 needs to be continuously corrected to ensure the accuracy and reliability of the inertial navigator 14.

Referring to FIGS. 1 and 3, in step S110, the drone 10 sets the corresponding relationship between the information of the inertial sensing unit 16 (i.e., inertial measurement unit (IMU)) and the GNSS signal. In step S111, the drone 10 lifts off to a place with a good GNSS signal to perform parameter calibration between the inertial sensing unit 16 and the GNSS. In step S112, the drone 10 receives the mission activity status and the encryption key of the mission sent by the ground control station. In step S113, the drone 10 starts to execute the mission 13.

That is, before executing the mission 13, the drone 10 needs to correctly set the numerical relationship between the GNSS and the inertial sensing unit 16, and make the drone 10 lift to the air for numerical comparison and calibration. In addition, in order to ensure the security of the sensitive data 19 of the drone 10, asymmetric key cryptography is configured to encrypt the collected sensitive information. Only those who have its asymmetric key can decrypt the sensitive data 19.

When executing the mission 13, the drone 10 can obtain the current speed and acceleration of each dimension. After inference, such as after inference by algorithm, the expected next GNSS position can be obtained. If the difference between the expected GNSS position and the actual GNSS position exceeds the GNSS accuracy range, it means that the drone 10 has been attacked by GNSS camouflage. The above algorithm, for example, performs a signal quality evaluation on the GNSS signals to obtain a signal evaluation index, and the signal evaluation index is configured to express the interference degree of the drone 10. In addition, when the signal evaluation index meets the target condition, an interference intensity analysis is performed on the GNSS signals to obtain an interference intensity index, and the target condition is configured to express the degree of interference abnormal signals or disguised GNSS signals in the navigation signal.

Referring to FIG. 1, in step S114, it is confirmed whether the drone 10 is attacked by the GNSS camouflage. If it is confirmed that the drone 10 is attacked by the GNSS camouflage, in step S115, the drone 10 enters an emergency mode and sends a signal to any one of group flying drones 10 performing the mission 13. For example, the drone 10 attacked by the GNSS camouflage sends an emergency signal (e.g., a help signal) to other drones 10 that are not attacked by the GNSS camouflage. If the drone 10 is not attacked by GNSS camouflage, the mission continues to be executed, and in step S118, it is confirmed whether the mission is completed. If it is confirmed that the mission is completed, step S123 is entered.

In step S115, once the emergency mode is entered, for example, when the satellite navigation system of the drone 10 is attacked and the drone 10 deviates from the original navigation path, in step S119, if the drone 10 finds other group flying drones 10 with the same mission, in step S120, the acquired sensitive data 19 can be transmitted to the other group flying drones that are normally performing the flight mission 13. In step S121, if the drone 10 does not find other group flying drones with the same mission, the drone 10 waits for rescue. If the waiting time for rescue exceeds the predetermined time, the drone 10 can delete the sensitive data 19 or encrypt the sensitive data 19 to prevent the sensitive data 19 from being maliciously obtained. In step S122, when the file (such as sensitive data 19) transmitted by the drone 10 is completed, step S123 is entered and the mission is completed.

On the other hand, after step S113, step S116 can be entered to confirm whether the satellite navigation system of the drone 10 is attacked and the drone 10 is falling rapidly toward the ground. If it is confirmed that the drone 10 is falling rapidly toward the ground, in step S117, the drone 10 enters an emergency mode and sends a signal to other group flying drones that are normally performing the mission 13. For example, the drone 10 that is attacked by GNSS camouflage sends an emergency signal (such as a help signal) to other group flying drones that are not attacked by GNSS camouflage.

In step S117, once the emergency mode is entered, for example, when the drone 10 is attacked and the drone 10 is falling rapidly toward the ground, in step S119, if the drone 10 finds other group flying drones with the same mission, in step S120, the acquired sensitive data 19 can be transmitted to the other group flying drones 10 that are normally performing the mission 13. In step S121, if the drone 10 does not find other group flying drones with the same mission, the drone 10 waits for rescue. If the waiting time for rescue exceeds a predetermined time, the drone 10 can delete the sensitive data 19 or encrypt the sensitive data 19 to prevent the sensitive data 19 from being maliciously obtained. In step S122, when the file (such as sensitive data 19) transmitted by the drone 10 is completed, step S123 is entered and the mission is completed.

In step S114, the drone 10 can determine whether the drone 10 deviates from the original navigation path based on whether the angle between the forward axis of the inertial navigator 14 and the true north direction of the navigation coordinate system is greater than a preset heading angle 15. In another embodiment, the drone 10 can obtain the corresponding relationship between the current GNSS time and the system time during flight. When the system time has an abnormal offset relationship with the latest GNSS time, it means that the drone 10 has been attacked by GNSS camouflage.

In step S116, the drone 10 can determine whether the drone 10 is falling rapidly toward the ground by detecting whether the downward velocity of the drone 10 is greater than a preset value according to the inertial sensing unit 16. Therefore, the drone 10 can use the inertial sensing unit 16 and the mission information to detect whether it is subjected to malicious attacks, causing the drone 10 to crash. For example, when the control unit 12 performs a mission, the information, such as the current altitude, the expected altitude, and various flight postures of the drone 10, can be obtained. When the altitude value drops rapidly or unexpectedly, and the downward acceleration value cannot be adjusted or improved, it means that the drone 10 may have entered a crash state.

In steps S119 and 120, when the group of drones are flying, they enter the monitoring mode to monitor whether there are drones 10 in the airspace that send out emergency signals of being attacked. The group flying drones can identify whether the drone 10 that sends out the emergency signal is legitimate by using the encryption key of the same flight mission 13. After the verification is completed, they will enter the data transmission mode. After the data transmission is completed, the drone 10 can bring the sensitive data 19 back to the ground station, and the ground station can identify which drone 10 has sent the mission data.

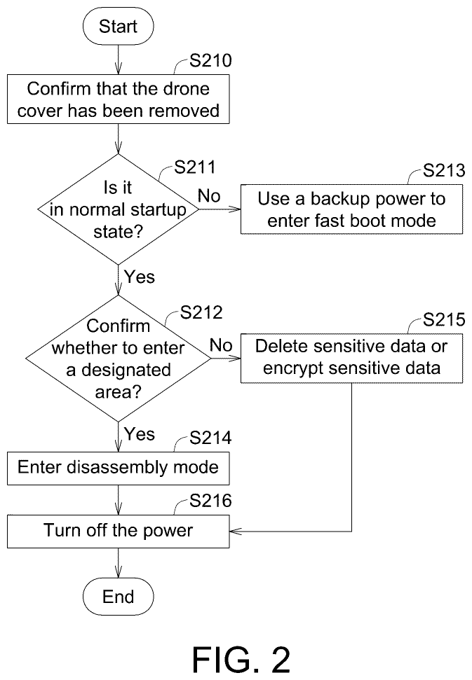

On the other hand, when the drone 10 is picked up without warning, the following process can be configured to confirm that the sensitive data 19 stored in the drone 10 would not be maliciously obtained. Referring to FIG. 2, a flowchart of a control method for a drone 10 according to another embodiment of the present application is shown. The control method for the drone 10 includes the following steps. In step S210, it is confirmed that the cover of the drone 10 has been removed. In step S211, it is confirmed whether the drone 10 is in a normal startup state. In step S212, when the drone 10 is powered on normally, the satellite navigation system of the drone 10 is started to confirm whether the drone 10 has entered a designated area. In step S214, when the drone 10 enters the designated area, the drone 10 enters a disassembly mode to obtain a sensitive data 19 stored in the drone 10. The above steps can be performed by the control unit 12.

In steps S211 and S212, when the cover of the drone 10 is removed, it is necessary to enter a designated area, which is a specific GNSS positioning position and a specific time range. After the cover of the drone 10 is removed, the drone 10 quickly confirms that the current environment is safe before entering the disassembly mode. Only in the disassembly mode, the backup power supply does not delete the sensitive data 19. Finally, in step S216, the drone 10 is shut down normally to turn off the power.

However, in step S213, when the drone 10 is not in a normal startup state, the drone 10 uses a backup power supply to enter a fast boot mode to start the satellite navigation system of the drone 10. In step S215, when the drone 10 does not enter the designated area, the drone 10 deletes the sensitive data 19 or encrypts the sensitive data 19. Therefore, in this embodiment, the drone 10 can use a sensor to detect whether the cover of the drone 10 has been removed, and use the backup battery to enter the fast boot mode to confirm that the sensitive data 19 would not be maliciously obtained.

In addition, when the satellite navigation system of the drone 10 is attacked and the drone 10 deviates from the original navigation path to a non-designated area, the drone 10 can perform the above-mentioned steps S210-S215, delete the sensitive data 19 or encrypt the sensitive data 19 to prevent the sensitive data 19 from being maliciously obtained. When the drone 10 is induced to be in the non-designated area, the drone 10 cannot enter a disassembly mode to ensure confidentiality and security.

Furthermore, when the satellite navigation system of the drone 10 is attacked and the drone 10 rapidly falls toward the ground to a non-designated area, or when the drone 10 is picked up and the cover of the drone 10 is removed, the drone 10 can perform the above-mentioned steps S210-S215, delete the sensitive data 19 or encrypt the sensitive data 19 to prevent the sensitive data 19 from being maliciously obtained.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A drone control method, comprising:
performing a mission to obtain sensitive data by a drone; and
when a satellite navigation system of the drone is attacked, the drone enters an emergency mode and sends a signal to other drones performing the mission.

2. The drone control method of claim 1, wherein when the satellite navigation system of the drone is attacked and the drone deviates from an original navigation path, the drone sends the signal and transmits the sensitive data to other drones performing the mission.

3. The drone control method of claim 2, wherein the drone determines whether the drone deviates from the original navigation path based on whether an angle between a forward axis of an inertial navigator and a true north direction of a navigation coordinate system is greater than a preset heading angle.

4. The drone control method of claim 1, wherein when the satellite navigation system of the drone is attacked and the drone is falling toward a ground, the drone sends the signal and transmits the sensitive data to other drones performing the mission.

5. The drone control method of claim 4, wherein the drone determines whether the drone is falling toward the ground by detecting whether a downward velocity of the drone is greater than a preset value according to an inertial sensing unit.

6. A drone control method, comprising:
confirming that a cover of a drone has been opened;
confirming whether the drone is in a normal startup state;
when the drone is normally powered on, starting a satellite navigation system of the drone to confirm whether the drone has entered a designated area; and
when the drone enters the designated area, the drone enters a disassembly mode to obtain sensitive data stored in the drone.

7. The drone control method of claim 6, wherein when the drone is not in the normal startup state, the drone uses a backup power supply to enter a fast boot mode to start the satellite navigation system of the drone.

8. The drone control method of claim 6, wherein when the drone does not enter the designated area, the drone deletes the sensitive data or encrypts the sensitive data.

9. The drone control method of claim 6, wherein when the satellite navigation system of the drone is attacked and the drone deviates from an original navigation path to a non-designated area, the drone determines that the drone does not enter the designated area, and deletes the sensitive data or encrypts the sensitive data.

10. The drone control method of claim 6, wherein when the satellite navigation system of the drone is attacked and the drone is falling toward a ground to a non-designated area, the drone determines that the drone does not enter the designated area, and deletes the sensitive data or encrypts the sensitive data.

11. A drone control device, comprising:
a control unit for performing a mission of a drone; and
a storage unit for storing sensitive data,
wherein when a satellite navigation system of the drone is attacked, the drone enters an emergency mode and sends a signal to other drones performing the mission.

12. The drone control device of claim 11, wherein the control unit determines that when the satellite navigation system of the drone is attacked and the drone deviates from an original navigation path, the drone sends the signal and transmits the sensitive data to other drones performing the mission.

13. The drone control device of claim 11, wherein the control unit comprises an inertial navigator, and the control unit determines whether the drone deviates from the original navigation path based on whether an angle between a forward axis of the inertial navigator and a true north direction of a navigation coordinate system is greater than a preset heading angle.

14. The drone control device of claim 11, wherein the control unit determines that when the satellite navigation system of the drone is attacked and the drone is falling toward a ground, the drone sends the signal and transmits the sensitive data to other drones performing the mission.

15. The drone control device of claim 14, wherein the control unit comprises an inertial sensing unit, and the control unit determines whether the drone is falling toward the ground based on whether a downward velocity of the drone detected by the inertial sensing unit is greater than a preset value.

16. The drone control device of claim 11, wherein the control unit is configured to perform following judgment steps:
confirming that a cover of the drone has been opened;
confirming whether the drone is in a normal startup state;
when the drone is normally powered on, starting the satellite navigation system of the drone to confirm whether the drone has entered a designated area; and
when the drone enters the designated area, the drone enters a disassembly mode to obtain the sensitive data stored in the drone.

17. The drone control device of claim 16, wherein when the drone is not in the normal startup state, the drone starts a backup power supply to start the satellite navigation system of the drone.

18. The drone control device of claim 16, when the drone does not enter the designated area, the drone deletes the sensitive data or encrypts the sensitive data.

19. The drone control device of claim 18, wherein when the satellite navigation system of the drone is attacked and the drone deviates from the original navigation path to a non-designated area, the drone determines that the drone does not enter the designated area, and deletes the sensitive data or encrypts the sensitive data.

20. The drone control device of claim 16, wherein when the satellite navigation system of the drone is attacked and the drone is falling toward a ground to a non-designated area, the drone determines that the drone does not enter the designated area, and deletes the sensitive data or encrypts the sensitive data.
